(19) United States
(12) Patent Application Publication
(10) Pub. No.: US 2023/0316490 A1
(43) Pub. Date: Oct. 5, 2023

(54) INSPECTION DEVICE, METHOD, AND COMPUTER PROGRAM FOR INSPECTION

(71) Applicant: TOYOTA JIDOSHA KABUSHIKI KAISHA, Toyota-shi Aichi-ken (JP)

(72) Inventors: Yasunori Nakamukai, Nagoya-shi Aichi-ken (JP); Yukiharu Tomita, Toyota-shi Aichi-ken (JP); Kazuhiro Arita, Toyota-shi Aichi-ken (JP); Takahiko Naitou, Nagoya-shi Aichi-ken (JP); Akihito Ito, Inazawa-shi Aichi-ken (JP)

(73) Assignee: TOYOTA JIDOSHA KABUSHIKI KAISHA, Toyota-shi Aichi-ken (JP)

(21) Appl. No.: 18/129,228

(22) Filed: Mar. 31, 2023

(30) Foreign Application Priority Data
Apr. 4, 2022 (JP) 2022-062521

(51) Int. Cl. G06T 7/00; G06V 10/764

(52) U.S. Cl. CPC G06T 7/0004; G06V 10/764; G06T 2207/10024; G06T 2207/10028

(57) ABSTRACT

An inspection device includes a processor configured to calculate an identification index indicating likelihood of each possible state of an object to be inspected regarding a predetermined inspection item by inputting a color image representing the object and a depth image representing the object into a classifier, and determine the state of the object regarding the inspection item, based on the identification index. The classifier calculates a first feature characterizing the object, based on the inputted color image; calculates a second feature characterizing the object, based on the inputted depth image; integrates the first feature and the second feature to calculate an integrated feature; and calculates the identification index, based on the integrated feature.

### CROSS-REFERENCE TO RELATED APPLICATION

This application is a national phase of Japanese Patent Application No. 2022-062521 filed on Apr. 4, 2022, the entire contents of which are herein incorporated by reference.

### FIELD

The present disclosure relates to an inspection device, a method, and a computer program for inspection based on, for example, an image and a depth image representing an object to be inspected.

### BACKGROUND

A technique to inspect an object, using a two-dimensional color image and a three-dimensional (3-D) image of the object taken with a camera and a 3-D camera, respectively, has been proposed (see Japanese Unexamined Patent Publication JP2020-183876A).

A system for recognizing feature points disclosed in JP2020-183876A executes computations on an image obtained by combining a visible-light image and a 3-D image of a first surface of a workpiece, in accordance with an algorithm made by deep learning to output positional information of feature points in the workpiece.

### SUMMARY

When a workpiece is inspected on the basis of only a visible-light image or a 3-D image representing the workpiece, the accuracy of inspection is insufficient in some cases.

It is an object of the present disclosure to provide an inspection device that can improve the accuracy of inspection of an object to be inspected with a color image and a depth image representing the object.

According to an embodiment, an inspection device is provided. The inspection device includes a processor configured to: calculate an identification index indicating likelihood of each possible state of an object to be inspected regarding a predetermined inspection item by inputting a color image representing the object and a depth image representing the object into a classifier, and determine the state of the object regarding the inspection item, based on the identification index. The classifier includes a first feature calculation part that calculates a first feature characterizing the object, based on the inputted color image; a second feature calculation part that calculates a second feature characterizing the object, based on the inputted depth image; an integration part that integrates the first feature and the second feature to calculate an integrated feature; and an identification part that calculates the identification index, based on the integrated feature.

In some embodiments, the processor is further configured to colorize the depth image.

In some embodiments, the first feature calculation part and the second feature calculation part of the classifier may have the same configuration.

According to another embodiment, a method for inspection is provided. The method includes calculating an identification index indicating likelihood of each possible state of an object to be inspected regarding a predetermined inspection item by inputting a color image representing the object and a depth image representing the object into a classifier; and determining the state of the object regarding the inspection item, based on the identification index. The classifier calculates a first feature characterizing the object, based on the inputted color image; calculates a second feature characterizing the object, based on the inputted depth image; integrates the first feature and the second feature to calculate an integrated feature; and calculates the identification index, based on the integrated feature.

According to still another embodiment, a non-transitory recording medium that stores a computer program for inspection is provided. The computer program includes instructions causing a computer to execute a process including calculating an identification index indicating likelihood of each possible state of an object to be inspected regarding a predetermined inspection item by inputting a color image representing the object and a depth image representing the object into a classifier; and determining the state of the object regarding the inspection item, based on the identification index. The classifier calculates a first feature characterizing the object, based on the inputted color image; calculates a second feature characterizing the object, based on the inputted depth image; integrates the first feature and the second feature to calculate an integrated feature; and calculates the identification index, based on the integrated feature.

According to the present disclosure, the inspection device has an effect of being able to improve the accuracy of inspection of an object to be inspected with a color image and a depth image representing the object.

### BRIEF DESCRIPTION OF DRAWINGS

FIG. 1 schematically illustrates the configuration of an inspection system according to an embodiment.

FIG. 2 illustrates the hardware configuration of an inspection device according to the embodiment.

FIG. 3 is a functional block diagram of a processor, related to an inspection process.

FIG. 4 schematically illustrates the configuration of a classifier used in the embodiment.

FIG. 5 is an operation flowchart of the inspection process.

### DESCRIPTION OF EMBODIMENTS

An inspection device, a method for inspection executed by the inspection device, and a computer program for inspection will now be described with reference to the attached drawings. The inspection device determines the state of an object to be inspected regarding a predetermined inspection item by inputting a color image and a depth image representing the object into a classifier. The classifier used by the inspection device includes a first feature calculation part that calculates a first feature characterizing the object from the color image representing the object, and a second feature calculation part that calculates a second feature characterizing the object from the depth image representing the object. The classifier further includes an integration part that integrates the first feature and the second feature to calculate an integrated feature, and an identification part that calculates an identification index indicating likelihood of each possible state of the object regarding the predetermined inspection item, based on the integrated feature. The inspection device determines the state of the object regarding the predetermined inspection item, based on the obtained identification index. In this way, the inspection device uses the result of integration of the features calculated from two types of images, i.e., a color image and a depth image representing an object for inspecting the object, and thus can obtain a more accurate result of inspection.

A depth image is an image in which each pixel has a value corresponding to the distance to a part of an object (in the present embodiment, a workpiece, which is an example of an object to be inspected) represented in the pixel. In a depth image, for example, a pixel of interest has a larger value as the distance to a part of an object represented in the pixel is greater, (in other words, the pixel becomes whiter as the distance to a part of an object represented in the pixel is greater). A depth image may be generated so that each pixel has a smaller value as the distance to a part of an object represented in the pixel is greater. The predetermined inspection item of an object to be inspected may be one related to determination whether the object is defective, whether the object is a defective or non-defective product, or whether the object is a foreign object. In the following embodiment, the predetermined inspection item of an object to be inspected by an inspection system is one for determining whether the object is defective; and possible states of the object include a state corresponding to defectiveness and a state corresponding to non-defectiveness.

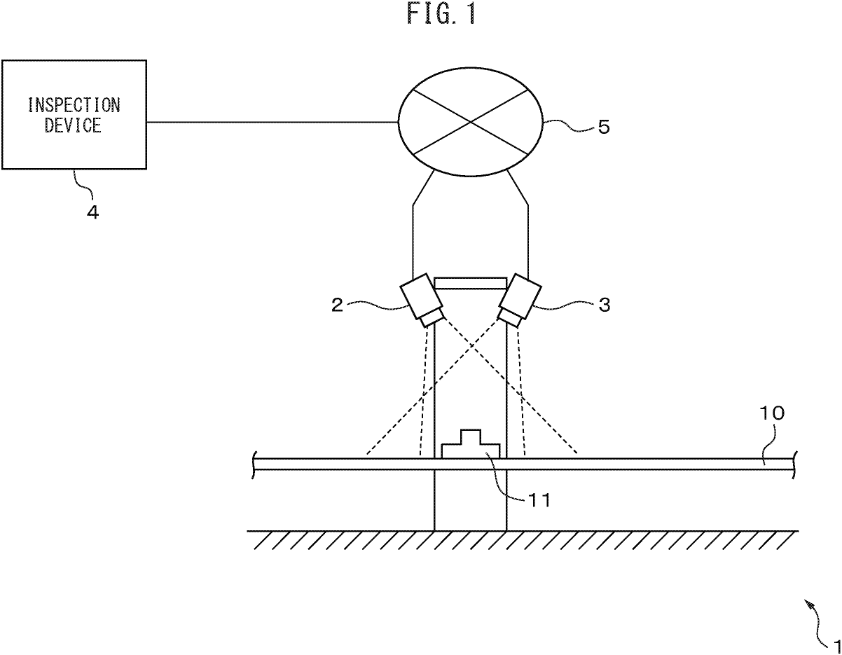

FIG. 1 schematically illustrates the configuration of an inspection system equipped with an inspection device according to an embodiment. The inspection system 1 includes a camera 2, a 3-D camera 3, and an inspection device 4. The camera 2 and the 3-D camera 3 are communicably connected to the inspection device 4 via a communication channel 5. The inspection system 1 determines whether a workpiece 11, which is an example of an object to be inspected, conveyed by a conveyor belt 10 is defective.

The camera 2, which is an example of the imaging unit, is mounted, for example, on a support member that straddles the conveyor belt 10 and oriented downward so that a picture of a workpiece 11 conveyed on the conveyor belt 10 can be taken from above. The camera 2 may be mounted on the support member so as to take a picture of a workpiece 11 from the side or from obliquely above. The camera 2 takes a picture of a workpiece 11 at timing when the workpiece 11 is conveyed into a capture area of the camera 2, thereby generating a color image representing the workpiece 11. In the present embodiment, a color image generated by the camera 2 is assumed to be represented in an RGB color coordinate system. However, a color image generated by the camera 2 may be represented in another color coordinate system, such as an HSV color coordinate system. The timing when a workpiece 11 is conveyed into the capture area of the camera 2 is notified, for example, via the communication channel 5 by a controller (not illustrated) that controls the conveyor belt 10. Every time a color image representing a workpiece 11 is generated, the camera 2 outputs the generated color image to the inspection device 4 via the communication channel 5.

The 3-D camera 3, which is an example of the stereoscopic imaging unit, is placed so that the 3-D camera 3 and the camera 2 can take a picture of the same surface of a workpiece 11. The 3-D camera 3 is mounted, for example, on a support member where the camera 2 is mounted and oriented downward so that a picture of a workpiece 11 conveyed on the conveyor belt 10 can be taken from above. In some embodiments, in the case where the camera 2 is mounted on the support member so as to take a picture of a workpiece 11 from the side or from obliquely above, the 3-D camera 3 may also be mounted so as to take a picture of the workpiece 11 from the same direction as the camera 2. In the case where the workpiece 11 is fixed while the camera 2 and the 3-D camera 3 are taking a picture of the workpiece 11, the 3-D camera 3 and the camera 2 may take the picture at different timings.

The 3-D camera 3 may be any of various types that can generate a depth image. For example, the 3-D camera 3 may be a time-of-flight camera. In this case, the 3-D camera 3 can generate a depth image by taking a single picture. Thus the 3-D camera 3 takes a single picture of a workpiece 11 at timing when the workpiece 11 is conveyed into a capture area of the 3-D camera 3, thereby generating a depth image representing the workpiece 11. The timing when a workpiece 11 is conveyed into the capture area of the 3-D camera 3 is notified, for example, via the communication channel 5 by the controller (not illustrated) that controls the conveyor belt 10. Alternatively, the 3-D camera 3 may be a stereo camera. In the case where the 3-D camera 3 is a stereo camera, when a workpiece 11 is conveyed into the capture area of the 3-D camera 3, individual cameras included in the 3-D camera 3 take a picture of the workpiece 11, thereby generating images. The images generated by the individual cameras are outputted to the inspection device 4 via the communication channel 5. In the case where the workpiece 11 is fixed while the camera 2 and the 3-D camera 3 are taking a picture of the workpiece 11, the 3-D camera 3 may be a structured illumination camera. In the case where the 3-D camera 3 is a structured illumination camera, when a workpiece 11 is conveyed into the capture area of the 3-D camera 3, the camera takes multiple pictures while varying the phase of structured light emitted from an illuminating light source included in the 3-D camera 3, thereby generating images. These images are outputted to the inspection device 4 via the communication channel 5.

The inspection device 4 is connected to the camera 2 and the 3-D camera 3 via the communication channel 5. The inspection device 4 determines whether a workpiece 11 is defective, based on a color image of the workpiece 11 received from the camera 2 as well as a depth image of the workpiece 11 or images for generating a depth image thereof, which are received from the 3-D camera 3.

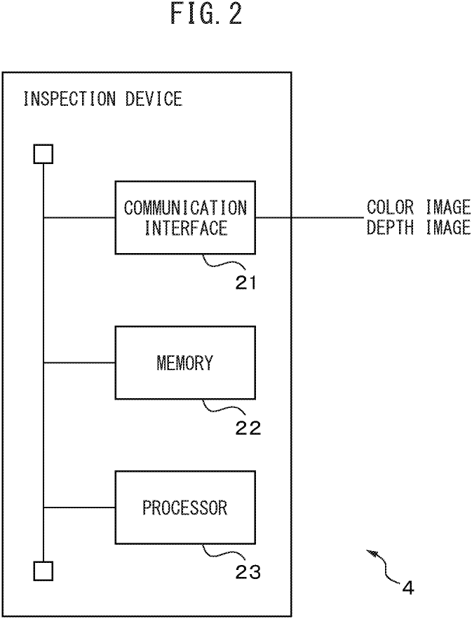

FIG. 2 illustrates the hardware configuration of the inspection device 4. The inspection device 4 includes a communication interface 21, a memory 22, and a processor 23. The inspection device 4 may further include a user interface (not illustrated), such as a keyboard and a display.

The communication interface 21, which is an example of a communication unit, includes, for example, a communication interface for connecting the inspection device 4 to the communication channel 5 and a circuit for executing processing related to transmission and reception of signals via the communication channel 5. The communication interface 21 receives a color image from the camera 2 via the communication channel 5, and passes the color image to the processor 23. The communication interface 21 also receives a depth image or images for generating a depth image from the 3-D camera 3 via the communication channel 5, and passes these images to the processor 23. In addition, the communication interface 21 may output the result of determination whether the workpiece 11 is defective, which is received from the processor 23, to another device (not illustrated) via the communication channel 5.

The memory 22, which is an example of a storage unit, includes, for example, a readable and writable semiconductor memory and a read-only semiconductor memory. The memory 22 may further include a storage medium, such as a semiconductor memory card, a hard disk, or an optical storage medium, and a device for accessing the storage medium.

The memory 22 stores a computer program for an inspection process executed by the processor 23 of the inspection device 4 as well as various parameters and various types of data used in the inspection process. As the various parameters used in the inspection process, the memory 22 stores, for example, a set of parameters for defining the configuration of a classifier. In addition, the memory 22 may temporarily store a color image and a depth image representing a workpiece 11 (or images used for generating a depth image). The memory 22 may further store the result of determination as to whether the workpiece 11 is defective.

The processor 23, which is an example of a processing unit, includes, for example, one or more CPUs and a peripheral circuit thereof. The processor 23 may further include an operating circuit for numerical operation or graphics processing. The processor 23 stores a color image of a workpiece 11 received from the camera 2 in the memory 22, and stores a depth image of the workpiece 11 or images for generating a depth image thereof, which are received from the 3-D camera 3, in the memory 22. Further, the processor 23 executes the inspection process on the workpiece 11, based on the color image and the depth image.

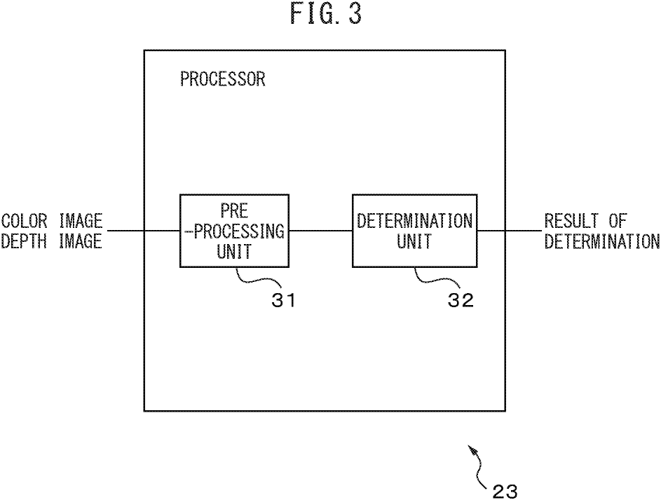

FIG. 3 is a functional block diagram of the processor 23, related to the inspection process. The processor 23 includes a pre-processing unit 31 and a determination unit 32. These units included in the processor 23 are functional modules, for example, implemented by a computer program executed by the processor 23. Alternatively, these units may be included in the processor 23 as a dedicated operating circuit.

The pre-processing unit 31 generates a depth image from images for generating a depth image when these images are obtained from the 3-D camera 3.

For example, in the case where the 3-D camera 3 is a stereo camera, the pre-processing unit 31 executes stereo matching between images generated by individual cameras included in the stereo camera, thereby generating a depth image representing a workpiece 11. In the case where the 3-D camera 3 is a structured illumination camera, the pre-processing unit 31 executes a predetermined operation to combine images obtained by irradiating a workpiece 11 with structured light having different phases, thereby generating a depth image representing the workpiece 11.

The pre-processing unit 31 further executes predetermined pre-processing on a color image and a depth image representing a workpiece 11 before input into a classifier. For example, the pre-processing unit 31 standardizes a color image by transforming the values of pixels of the color image in accordance with the following expressions.

$$\begin{matrix}\left(\text{R-0} \text{.485*255}\right) / \left(0.299 * 255\right) \\ \left(\text{G-0} \text{.456*255}\right) / \left(0.224 * 255\right) \\ \left(\text{B-0} \text{.406*255}\right) / \left(0.225 * 255\right)\end{matrix} \qquad \text{(1)}$$

R, G, and B denote the values of red, green, and blue components of a pixel of interest, respectively. Each color component of individual pixels of the color image before standardization is assumed to have a value in the range of 0 to 255.

Alternatively, the pre-processing unit 31 may standardize a color image by transforming the values of pixels of the color image in accordance with the following expressions.

$$\begin{matrix}\left(\text{R-} {μ}_{\text{R}}\right) / {\text{σ}}_{\text{R}} \\ \left(\text{G-} {μ}_{\text{G}}\right) / {\text{σ}}_{\text{G}} \\ \left(\text{B-} {μ}_{\text{B}}\right) / {\text{σ}}_{\text{B}}\end{matrix} \qquad \text{(2)}$$

R, G, and B denote the values of red, green, and blue components of a pixel of interest, respectively. µ_{R}, µ_{G}, and µ_{B} denote the averages of red, green, and blue components over the whole color image, respectively. σ_{R}, σ_{G}, and σ_{B} denote the standard deviations of red, green, and blue components over the whole color image, respectively.

Alternatively, the pre-processing unit 31 may normalize a color image by dividing the color components of each pixel of the color image by a possible maximum (in this example, 255). Alternatively, the pre-processing unit 31 may execute contrast conversion of a color image by converting the values of the color components of individual pixels of the color image in accordance with a predetermined γ-curve. Further, the pre-processing unit 31 may apply other pre-processing, such as processing to normalize histograms of the color components, to a color image. Application of such pre-processing to a color image enables the pre-processing unit 31 to reduce variations of color images inputted into a classifier. This enables the pre-processing unit 31 to indirectly improve the accuracy of identification by the classifier as to whether the workpiece 11 is defective.

The pre-processing unit 31 applies predetermined coloring processing to a depth image to colorize the depth image. As such coloring processing, the pre-processing unit 31 can use, for example, processing with a predetermined color conversion algorithm by which a whiter pixel becomes redder and a blacker pixel becomes bluer. Alternatively, the pre-processing unit 31 may colorize a depth image by inputting the depth image into a model that has been trained to convert an inputted monochrome image into a color image. As such a model, the pre-processing unit 31 can use a “deep neural network (DNN)” having architecture of a convolutional neural network (CNN) type including multiple convolution layers.

To the colorized depth image, the pre-processing unit 31 applies pre-processing similar to that applied to the color image. For example, the pre-processing unit 31 standardizes the colorized depth image in accordance with expression (1) or (2). Alternatively, the pre-processing unit 31 may normalize the colorized depth image by applying normalization processing like that described above to the colorized depth image. Alternatively, the pre-processing unit 31 may apply other pre-processing like that described above to the colorized depth image. Application of such pre-processing to a depth image enables the pre-processing unit 31 to reduce variations of depth images inputted into a classifier. This enables the pre-processing unit 31 to indirectly improve the accuracy of identification by the classifier as to whether the workpiece 11 is defective. In addition, application of coloring processing to a depth image by the pre-processing unit 31 enables use of DNNs having the same configuration as first and second feature calculation parts.

To the colorized depth image, the pre-processing unit 31 may apply pre-processing different from that applied to the color image. For example, the pre-processing unit 31 may standardize the color image in accordance with one of expressions (1) and (2), and standardize the colorized depth image in accordance with the other of expressions (1) and (2). Alternatively, the pre-processing unit 31 may standardize the color image in accordance with expression (1) or (2), and normalize the colorized depth image by normalization processing like that described above. In this way, the pre-processing unit 31 can execute pre-processing suitable for the individual images by applying different pre-processing to the color image and the colorized depth image.

Alternatively, the pre-processing unit 31 may apply predetermined pre-processing and then coloring processing to a depth image.

The pre-processing unit 31 outputs the pre-processed color image and the pre-processed and colorized depth image to the determination unit 32.

The determination unit 32 calculates an identification index indicating likelihood of each possible state of the workpiece 11 regarding a predetermined inspection item by inputting the pre-processed color image and the pre-processed and colorized depth image into a classifier. In the present embodiment, the classifier calculates confidence scores indicating likelihood of the presence and absence of a defect in the workpiece 11 as the identification index. In the following, a pre-processed color image will be referred to simply as a “color image”; a pre-processed and colorized depth image as a “depth image.”

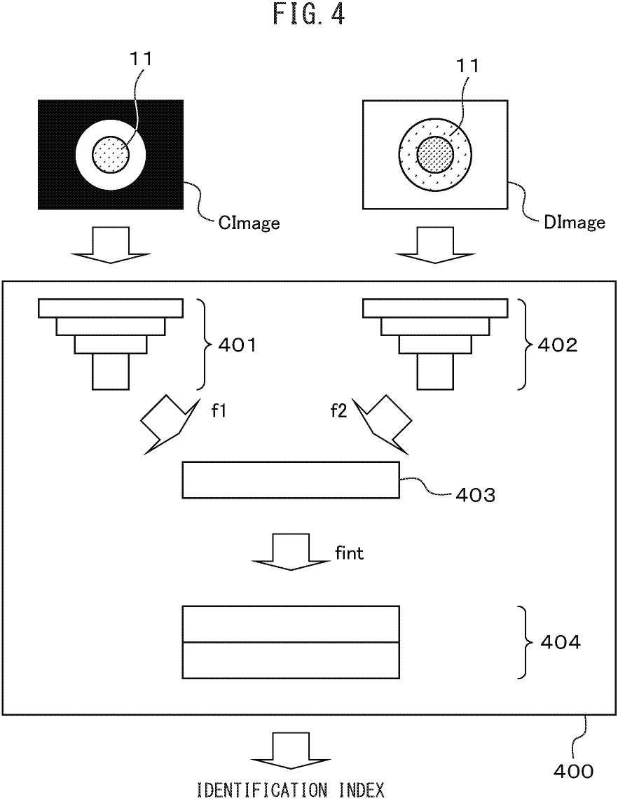

FIG. 4 schematically illustrates the configuration of the classifier used in the present embodiment. The classifier 400 includes a first feature calculation part 401, a second feature calculation part 402, an integration part 403, and an identification part 404.

The first feature calculation part 401, into which a color image CImage is inputted, calculates a first feature f1 characterizing the workpiece 11 represented in the color image. The second feature calculation part 402, into which a depth image DImage is inputted, calculates a second feature f2 characterizing the workpiece 11 represented in the depth image. To achieve this, the first and second feature calculation parts 401 and 402 each include multiple convolution layers. The first and second feature calculation parts 401 and 402 may each further include at least one pooling layer disposed between two successive convolution layers or on the output of the convolution layer closest to the output. The first and second feature calculation parts 401 and 402 may each further include at least one fully-connected layer disposed closer to the output than the convolution layers. The first and second feature calculation parts 401 and 402 each further include an activation layer on the output of each convolution layer and on the output of each fully-connected layer.

Each convolution layer of the first feature calculation part 401 calculates a feature map by executing a convolution operation on the inputted color image or a feature map outputted from the immediately preceding layer. The pooling layer executes max pooling or global average pooling on a feature map outputted from the immediately preceding layer. The fully-connected layer executes a fully-connected operation on a feature map outputted from the immediately preceding layer. The activation layer executes an activation operation, such as ReLU or Mish, on the output from the immediately preceding layer. The first feature calculation part 401 outputs the result of operations outputted from the layer disposed closest to the output, to the integration part 403 as the first feature. The outputted first feature includes one- or two-dimensionally arrayed feature variables for each channel. In the case where the first feature calculation part 401 includes a pooling layer disposed between two successive convolution layers, feature maps of different resolutions are obtained before and after the pooling layer. These feature maps of different resolutions may be outputted to the integration part 403 as the first feature. Alternatively, in the case where the first feature calculation part 401 includes a fully-connected layer, these feature maps of different resolutions may be inputted into the fully-connected layer.

Similarly, each convolution layer of the second feature calculation part 402 calculates a feature map by executing a convolution operation on the inputted depth image or a feature map outputted from the immediately preceding layer. The pooling layer executes max pooling or global average pooling on a feature map outputted from the immediately preceding layer. The fully-connected layer executes a fully-connected operation on a feature map outputted from the immediately preceding layer. The activation layer executes an activation operation, such as ReLU or Mish, on the output from the immediately preceding layer. The second feature calculation part 402 outputs the result of operations outputted from the layer disposed closest to the output, to the integration part 403 as the second feature. The outputted second feature includes one- or two-dimensionally arrayed feature variables for each channel. In the case where the second feature calculation part 402 includes a pooling layer disposed between two successive convolution layers as described above, feature maps of different resolutions are obtained before and after the pooling layer. These feature maps of different resolutions may be outputted to the integration part 403 as the second feature. Alternatively, in the case where the second feature calculation part 402 includes a fully-connected layer, these feature maps of different resolutions may be inputted into the fully-connected layer.

In particular, the second feature calculation part 402 may have the same configuration as the first feature calculation part 401. In the present embodiment, the meaning of these two feature calculation parts having the same configuration is that the configurations of layers of the two feature calculation parts and the types of operations of corresponding layers are the same. Thus, for example, weighting factors used for operations of individual layers, which have different values by being trained individually, may differ from each other as long as the configurations of layers of the two feature calculation parts and the types of operations of corresponding layers are the same.

According to a modified example, the first and second feature calculation parts 401 and 402 may include layers that execute an operation based on self attention on an inputted color image or depth image to calculate a feature map, instead of the convolution layers.

The integration part 403 integrates the first and second features f1 and f2 to calculate an integrated feature fint. To achieve this, for each pair of corresponding feature variables of the first and second features f1 and f2, the integration part 403 calculates the sum of the feature variables included in the pair, and determines the calculated sum as the value of a corresponding feature variable of the integrated feature fint. Alternatively, for each pair of corresponding feature variables of the first and second features f1 and f2, the integration part 403 may calculate an average or a weighted average of the feature variables included in the pair, and determine the calculated average or weighted average as the value of a corresponding feature variable of the integrated feature fint. In the case of a weighted average, the weighting factors of the first and second features f1 and f2 are set, for example, based on pre-measured contributions of the color image and the depth image to the accuracy of identification. More specifically, when contribution of the color image to the accuracy of identification is greater than that of the depth image, the weighting factors of the feature variables included in the first feature f1 are set greater than those of the feature variables included in the second feature f2. Conversely, when contribution of the depth image to the accuracy of identification is greater than that of the color image, the weighting factors of the feature variables included in the second feature f2 are set greater than those of the feature variables included in the first feature f1. Alternatively, these weighting factors may also be determined at training the classifier, depending on the result of training.

Alternatively, for each pair of corresponding feature variables of the first and second features f1 and f2, the integration part 403 may identify the maximum of the feature variables included in the pair, and determine the identified maximum as the value of a corresponding feature variable of the integrated feature fint. Alternatively, the integration part 403 may make the integrated feature fint so as to include both the feature variables included in the first feature f1 and those included in the second feature f2. In this case, the integrated feature fint may be made so that corresponding feature variables of the first and second features f1 and f2 are arrayed.

The integration part 403 outputs the integrated feature fint to the identification part 404.

The identification part 404 includes an output layer that executes a softmax operation or a sigmoid operation on the integrated feature fint to calculate confidence scores of defectiveness and non-defectiveness in the workpiece 11. The identification part 404 may further include a layer for metric learning, such as SphereFace, CosFace, or ArcFace, closer to the input than the output layer that executes a softmax operation or a sigmoid operation. The identification part 404 may further include at least one fully-connected layer closer to the input than the output layer and the layer for metric learning, and an activation layer on the output of each fully-connected layer. In some embodiments, in the case where the first and second feature calculation parts 401 and 402 do not include a fully-connected layer, the identification part 404 includes at least one fully-connected layer.

Upon input of the integrated feature fint, the identification part 404 executes operations of the above-described layers to calculate confidence scores of defectiveness and non-defectiveness in the workpiece 11 as an identification index. In particular, in the case where the output layer is configured to execute a softmax operation, the sum of the confidence score of defectiveness and that of non-defectiveness is 1.

The classifier 400 is trained in advance in accordance with a predetermined training algorithm, such as backpropagation. Training data used for training the classifier 400 includes, for example, those color images and depth images representing the same surface of defective workpieces 11 which are obtained by taking pictures of the defective workpieces 11 with the camera 2 and the 3-D camera 3 simultaneously. The training data further includes those color images and depth images representing the same surface of non-defective workpieces 11 which are obtained by taking pictures of the non-defective workpieces 11 with the camera 2 and the 3-D camera 3 simultaneously. The classifier 400 trained with a large amount of such training data can accurately identify whether a workpiece 11 represented in an inputted color image and depth image is defective.

As the classifier 400 may be used an existing trained DNN, such as a VGG-16, VGG-19, or EfficientNet. In this case, of the layers included in the existing DNN, an output layer, or the output layer, an fully-connected layer, and an activation layer on the output of the fully-connected layer are used as the identification part 404; and the layers except those of the identification part 404 are duplicated as the first and second feature calculation parts 401 and 402. Thus the first and second feature calculation parts 401 and 402 have the same configuration. In addition to these, the above-described integration part 403 is provided. In this case, since the DNN used is trained to a certain extent, transfer learning with a relatively small amount of training data will reduce the computational burden at training and improve the accuracy of identification by the classifier 400 as to whether the workpiece 11 is defective. In an actual process in particular, it may be difficult to prepare a large amount of training data representing defective workpieces 11 because defective workpieces 11 are rare. However, use of such transfer learning enables improving of the accuracy of identification by the classifier 400 as to whether the workpiece 11 is defective, even with a small amount of training data.

When the confidence score of defectiveness outputted from the classifier is higher than that of non-defectiveness, the determination unit 32 determines that the workpiece 11 is defective. Conversely, when the confidence score of non-defectiveness is not lower than that of defectiveness, the determination unit 32 determines that the workpiece 11 is not defective. Alternatively, when the confidence score of defectiveness is higher than a predetermined determination threshold, the determination unit 32 may determine that the workpiece 11 is defective; and when the confidence score of defectiveness is not higher than the predetermined determination threshold, the determination unit 32 may determine that the workpiece 11 is not defective.

The determination unit 32 notifies a user of the result of determination whether the workpiece 11 is defective, via a user interface (not illustrated). Alternatively, the determination unit 32 may output the result of determination whether the workpiece 11 is defective, to another device via the communication interface 21 and the communication channel 5.

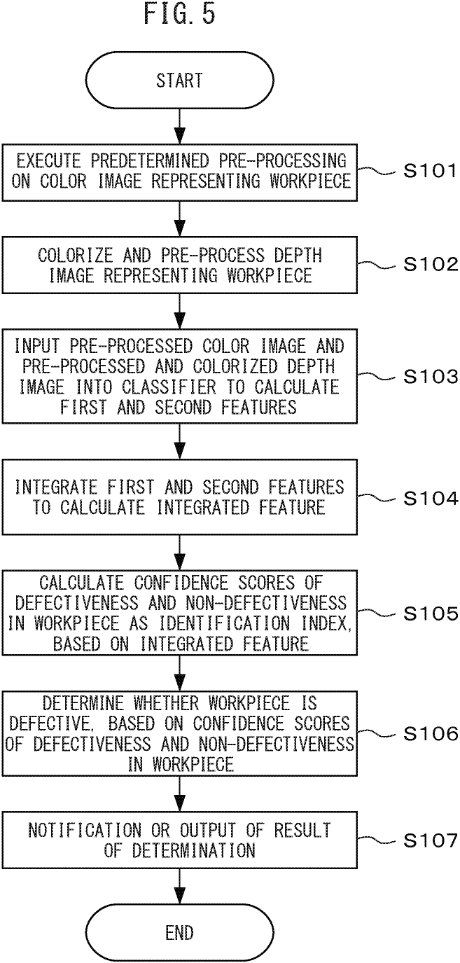

FIG. 5 is an operation flowchart of the inspection process. The processor 23 executes the inspection process in accordance with the operation flowchart described below.

The pre-processing unit 31 of the processor 23 executes predetermined pre-processing on a color image (step S101). The pre-processing unit 31 executes coloring processing and predetermined pre-processing on a depth image (step S102). Processing of steps S101 and S102 may be executed in reverse order or in parallel.

The determination unit 32 of the processor 23 inputs the pre-processed color image and the pre-processed and colorized depth image into the classifier. The classifier calculates first and second features (step S103). The classifier further integrates the first and second features to calculate an integrated feature (step S104). The classifier then calculates confidence scores of defectiveness and non-defectiveness in the workpiece 11 as an identification index, based on the integrated feature (step S105).

The determination unit 32 determines whether the workpiece 11 is defective, based on the confidence scores of defectiveness and non-defectiveness in the workpiece 11 calculated as the identification index (step S106). The determination unit 32 notifies a user of the result of determination via a user interface, or outputs the result to another device via the communication interface 21 and the communication channel 5 (step S107). The processor 23 then terminates the inspection process.

As has been described above, the inspection device determines the state of an object to be inspected regarding a predetermined inspection item by inputting a color image and a depth image representing the object into a classifier. The classifier used by the inspection device calculates first and second features characterizing the object from the color image and the depth image representing the object. The classifier calculates an identification index indicating likelihood of each possible state of the object regarding the predetermined inspection item, based on an integrated feature obtained by integrating the first and second features. The inspection device then determines the state of the object regarding the predetermined inspection item, based on the obtained identification index. In this way, the inspection device uses the result of integration of the features calculated from two types of images, i.e., a color image and a depth image representing an object for inspecting the object, and thus can obtain a more accurate result of inspection.

According to a modified example, the pre-processing unit 31 may execute predetermined pre-processing on only a color image or a depth image. Alternatively, the pre-processing unit 31 may omit to colorize a depth image. Alternatively, the pre-processing unit 31 may omit to execute processing other than generation of a depth image. This reduces the amount of computation of the whole inspection process. When the environment of image capture in which the camera 2 and the 3-D camera 3 take a picture of a workpiece 11 is expected to be roughly uniform or when the classifier is trained taking account of variations in the environment of image capture, the accuracy of inspection can be maintained even without pre-processing. In some embodiments, when colorization of a depth image is omitted, the first and second feature calculation parts included in the classifier may have different configurations. This is because the structure of a color image (three channels of R, G, and B) inputted into the first feature calculation part differs from that of a depth image (only one channel) inputted into the second feature calculation part.

The computer program for executing the processing of the units included in the processor 23 of the inspection device 4 may be provided in a form recorded on a computer-readable portable storage medium, such as a semiconductor memory, a magnetic medium, or an optical medium.

As described above, those skilled in the art may make various modifications according to embodiments within the scope of the present disclosure.

What is claimed is:

1. An inspection device comprising
a processor configured to:
calculate an identification index indicating likelihood of each possible state of an object to be inspected regarding a predetermined inspection item by inputting a color image representing the object and a depth image representing the object into a classifier, and
determine the state of the object regarding the inspection item, based on the identification index, wherein
the classifier comprises
a first feature calculation part that calculates a first feature characterizing the object, based on the color image;
a second feature calculation part that calculates a second feature characterizing the object, based on the depth image;
an integration part that integrates the first feature and the second feature to calculate an integrated feature; and
an identification part that calculates the identification index, based on the integrated feature.

2. The inspection device according to claim 1, wherein the processor is further configured to colorize the depth image.

3. The inspection device according to claim 2, wherein the first feature calculation part and the second feature calculation part of the classifier have the same configuration.

4. A method for inspection, comprising:
calculating an identification index indicating likelihood of each possible state of an object to be inspected regarding a predetermined inspection item by inputting a color image representing the object and a depth image representing the object into a classifier; and
determining the state of the object regarding the inspection item, based on the identification index, wherein
the classifier
calculates a first feature characterizing the object, based on the color image;
calculates a second feature characterizing the object, based on the depth image;
integrates the first feature and the second feature to calculate an integrated feature; and
calculates the identification index, based on the integrated feature.

5. A non-transitory recording medium that stores a computer program for inspection, the computer program causing a computer to execute a process comprising:
calculating an identification index indicating likelihood of each possible state of an object to be inspected regarding a predetermined inspection item by inputting a color image representing the object and a depth image representing the object into a classifier; and
determining the state of the object regarding the inspection item, based on the identification index, wherein
the classifier
calculates a first feature characterizing the object, based on the color image;
calculates a second feature characterizing the object, based on the depth image;
integrates the first feature and the second feature to calculate an integrated feature; and
calculates the identification index, based on the integrated feature.
